(19) United States
(12) Patent Application Publication
(10) Pub. No.: US 2020/0333140 A1
(43) Pub. Date: Oct. 22, 2020

(54) IMAGE DATA CAPTURING ARRANGEMENT

(71) Applicants: ELSON SPACE ENGINEERING ESE LIMITED, Wells (GB); ORDNANCE SURVEY LIMITED, Southampton (GB)

(72) Inventors: Andrew ELSON, Wells (GB); Mike ROBERTS, Wells (GB); Steve HANCOCK, Southampton (GB); Simon ASHBY, Southampton (GB)

(21) Appl. No.: 16/085,356

(22) PCT Filed: Mar. 13, 2017
(86) PCT No.: PCT/GB2017/050670

§ 371 Date: Sep. 14, 2018

(30) Foreign Application Priority Data
Mar. 15, 2016 (GB) 1604415.8

(51) Int. Cl. G01C 21/02; H04N 5/33; H04N 5/247; G01S 13/89; G01S 17/89

(52) U.S. Cl. CPC G01C 21/025; H04N 5/332; G01S 17/89; G01S 13/89; H04N 5/247

(57) ABSTRACT

An image data capturing arrangement (1) has at least two image data capturing devices. At least one first image data capturing device (2) is adapted to capture data of one or more first images of an object along a first image capturing axis 4, and at least one second image data capturing device (6) is adapted to capture data of one or more second images of stars along a second image capturing axis 8. The second image capturing axis (8) has a known orientation relative to the first image capturing axis (4), and a reference clock for assigning a time stamp to each first and second image data.

### FIELD OF THE INVENTION

The present invention relates to an image capturing arrangement, and to an image capturing system and an aerial vehicle having the image capturing arrangement. The invention also relates to a method of capturing images.

### BACKGROUND TO THE INVENTION

Capturing images of, for example, the Earth, its surface or atmosphere, is best carried out from a position above the Earth.

Locating an image capturing arrangement such as a camera or sensor at stratospheric altitudes has the advantage that the stratosphere exhibits very stable atmospheric conditions in comparison to other layers of the Earth's atmosphere. Wind strengths and turbulence levels are at a minimum between altitudes of approximately 18 to 30 kilometres.

In order to reach a target altitude the image capturing arrangement may be mounted on an aerial vehicle such as a vehicle adapted to fly in the stratosphere, for example an unmanned aerial vehicle (UAV), or a balloon.

Once the image capturing arrangement reaches a target operating altitude, the challenge is to determine the orientation or attitude of the image capturing arrangement whilst the images are being captured. The platform or vehicle carrying the image capturing device may be subject to variation in roll, pitch or yaw angles, for example due to twisting or pendulum swings if suspended below a balloon, or structural deflection and flight path if located on an aerial vehicle. In particular, images may be captured at unpredictable angles of inclination or declination of the image capturing arrangement. Accurate information regarding where the image capturing device is in 3D space and what its orientation is, enables determination of where the image capturing device is actually pointing at the time of capturing images.

### SUMMARY OF THE INVENTION

A first aspect of the invention provides an image data capturing arrangement comprising at least one first image data capturing device adapted to capture data of one or more first images of an object along a first image capturing axis, at least one second image data capturing device adapted to capture data of one or more second images of stars along a second image capturing axis, the second image capturing axis having a known orientation relative to the first image capturing axis, and a reference clock for assigning a time stamp to each first and second image.

A second aspect of the invention provides a method of capturing image data comprising the steps of providing an image data capturing arrangement including at least one first image data capturing device adapted to capture data of one or more first images of an object along a first image capturing axis, at least one second image data capturing device adapted to capture data of one or more second images of stars along a second image capturing axis and a common reference clock, capturing data of one or more first images of the object with the first image data capturing device, capturing data of one or more second images with the second image data capturing device, the second image capturing axis having a known orientation relative to the first image capturing axis, and assigning a time stamp to each first image and each second image with the common reference clock.

Advantageously the image data capturing arrangement of the first aspect enables the orientation of the first image data capturing device at the time of capturing image(s) of the object to be accurately ascertained. In the following reference to ‘image’ may also refer to ‘image data’, i.e. data of an image.

It is known to use the stars for navigation, since stars and galaxies have generally fixed positions over time and therefore provide a reliable datum by which to orientate oneself. By providing a second image capturing device directed towards the stars, correlation with known star charts allows the orientation of the first image capturing device to be determined. The image capturing arrangement may therefore provide a compact and lightweight arrangement suitable for use on an aerial platform such as a balloon or UAV.

A star is defined as a luminous sphere of plasma held together by its own gravity. For the purpose is this invention it is a high intensity radiation source in space.

The reference clock is configured to record a time stamp to each first or second image taken. The time stamp may include time and optionally further date information.

Each image capturing device may be a camera or sensor or other device for capturing images. The images may be photographs, film or video signals. The device will typically record images in digital form. There is no requirement that the first and second image capturing devices detect the same radiation wavelengths or operate using the same technology.

The first image capturing device or second image capturing device may be adapted to capture images based on one or more ranges of wavelengths of electromagnetic radiation within a spectrum, the range of wavelengths corresponding to that of visible light or ultra violet or X-ray or gamma ray or infra-red or microwave or radio waves or any other part of the electro-magnetic spectrum. The first image capturing device or second image capturing device may be a camera, a radio detecting and ranging (RADAR) sensor or a Light Detection and Ranging (LiDAR) sensor for example.

The first image data capturing device may be different than the second image data capturing device. In particular, the first image data capturing device may be adapted to capture data of one or more object images based on a first range of wavelengths of electromagnetic radiation within a spectrum, and the second image data capturing device may be adapted to capture data of one or more star images based on a second range of wavelengths of electromagnetic radiation within the spectrum different than the first range of wavelengths. Advantageously this enables imaging of an object, such as the Earth, from an aerial vehicle flying above the Earth during daylight hours, e.g. by capturing star image data in the infra-red part of the spectrum and capturing object image data in the visible light part of the spectrum. For an aerial vehicle flying in the Earth's atmosphere, e.g. in the stratosphere, the sunlight reflected from Earth may be sufficiently intense to obscure capture of star image data in the visible light part of the spectrum, yet Earth image data capture in the visible light part of the spectrum may be desirable.

The image capturing axes define a direction which relates to where each device is pointing towards, or focussed on, at the time of capturing an image. In a visible light camera, the image capturing axis is known as the optical axis or the principal axis, and is the straight line passing through the geometrical centre of a lens and joining the two centres of curvature of its surfaces. An image capturing axis is generically a straight line from the centre of the image being captured. A camera or sensor operating at non-visible light wavelengths also has a principal axis via which it focuses, detects radiation and captures images.

The image capturing axes have a known orientation with respect to each other, meaning that the orientation is accurately arranged. The orientation may be fixed, or may be adjustable in use as long as any variation in orientation is controlled accurately.

The first image capturing device may capture images of various objects; the object of study may be the Earth, for example its surface or atmosphere. Equally, images may be captured of other celestial objects, for example the Moon, Mars, stars or other galaxies.

In order to filter out daylight and hence ‘see’ and capture images of stars, the second image capturing device may include an infra-red filter, which allows only light at the infrared end of the electromagnetic spectrum to pass through. This filter may not be required if the first images are being captured at night.

The image capturing arrangement may include a data storage module, and/or an image data processing module and/or a data transmission module. The data transmission module may also include data receiving means. Captured first and second images may be stored and/or processed within the camera arrangement before being transmitted to a remote receiving station. For example, images may be stored without any processing, and (wirelessly) transmitted directly to the remote station for processing, or the data may be processed or part processed within the camera arrangement prior to transmission to the remote station.

An image capturing system may comprise the image capturing arrangement of the first aspect, and may also comprise a position determining device arranged to determine a spatial position of the image capturing arrangement relative to the object. The position determining device may determine a spatial position of the image capturing arrangement by accessing a repository of star images and correlating star images from the repository with a plurality of second images of stars captured by the second image capturing device. Alternatively or additionally, the position determining device may comprise a receiver for receiving satellite signals and the position determining device may be arranged to determine the spatial position of the image capturing arrangement relative to the object according to the satellite signals received.

The position determining device may be further configured to determine the latitude, longitude, altitude and attitude of the image capturing arrangement. The position determining device may be used to determine this spatial position of the image capturing arrangement at the time of image capture by the image capturing arrangement.

If the object is not the Earth but another celestial body such as the Moon or Mars, then the positioning receiver may need to access satellites arranged in orbit about that celestial body, which may need to be in place and providing communication signals for location purposes.

At least a part of the position determining device may be arranged remotely from the image capturing arrangement. Alternatively, images may be stored and processed by the position determining device on board the camera arrangement, and processing may include one or more steps, for example correlation of first images, second images and each time stamp, logging of position related data such as GPS or derivation of position from the second images of stars versus star images in a repository by a star tracking technique.

The image capturing system may further comprise an information repository providing the object's position and orientation over time in relation to the stars. A processor may be configured to use the object's position and orientation correlated with the reference clock together with the spatial position and attitude of the image capturing device in order to determine the location of the or each captured first image on the object and assign object reference location data to the or each first image.

Once the position and direction of the image capturing axis of the first image capturing device at the time of capturing image(s) is known, then this information can be correlated with information about the object. If the object is moving, for example if the object is the Earth, then information on the Earth's rotation and orbit can be used to accurately identify the location on the Earth of the first image(s) to an accuracy of 1 metre squared on the surface of the Earth, or an accuracy in the range 1 metre to approximately 4 metres. The image(s) can be referenced and a series of images of the object can be taken and placed together to provide a map of the object, (in this example the surface of the Earth.)

The object under study by the image capturing system may be the Earth. Alternatively, the object may be a celestial object other than the Earth. The spatial position of the object may be obtained by reference to an information repository correlating the position and orientation of the object relative to the Earth over time, or may provide positional data relative to an alternative datum such as star positions.

The processor may be remote from the image capturing arrangement. Alternatively, the processor may be located with the camera arrangement on board an aerial vehicle comprising the image capturing arrangement.

According to the second aspect, the method of capturing images may comprise correlating the one or more first images with the one or more second images according to the time stamp of each first image and each second image. The method may comprise determining a spatial position of the image capturing arrangement, this may be relative to the Earth according to satellite signals received. The spatial position of the image capturing arrangement may be determined by accessing a repository of star images and correlating star images from the repository with a plurality of second images of stars captured by the second image capturing device. The method may comprise determining one or more of the spatial position including latitude, longitude and altitude, and attitude of the image capturing arrangement.

The method may also comprise determining the location on the object of the or each captured first image using the spatial position and attitude of the image capturing device together with information on the object's position and orientation at the time stamp of the or each first image. The method step of determining the location on the object of each captured first image may be repeated for each first image in a series of first images in order to map the object.

The object may be the Earth, alternately the object may be a celestial object other than the Earth. The spatial position of the object may be obtained by reference to information correlating the position and orientation of the object relative to the Earth over time, or may provide positional data relative to an alternative datum such as star positions. One or more of the steps of correlating first images with second images, determining image capturing device spatial position, determining image capturing device attitude and determining the location on the object of the or each captured first image may occur remotely of the image capturing arrangement. The method may further comprise mounting the image capturing arrangement to an aerial vehicle, flying the aerial vehicle and capturing first and second images during flight.

### BRIEF DESCRIPTION OF THE DRAWINGS

Embodiments of the invention will now be described with reference to the accompanying drawings, in which:

FIG. 1 is a schematic view of an embodiment of an image capturing arrangement, with a first image capturing device pointing towards the Earth and a second image capturing device pointing towards the stars,

FIG. 2 is a schematic view of an alternative arrangement of the image capturing arrangement, whereby the first image capturing device and the second image capturing device are mounted to a generally linear platform and offset from each other along the linear axis of the platform,

FIG. 3 is a schematic view of a further arrangement of the image capturing arrangement, whereby the first image capturing device and the second image capturing device are mounted at an angle to each other,

FIG. 4 is a schematic view of a yet further arrangement of the image capturing arrangement, whereby multiple first image capturing devices and multiple second image capturing devices are arranged on a mounting platform,

FIG. 5 is a schematic perspective view of an unmanned aerial vehicle adapted to lift an embodiment of the image capturing arrangement to altitude,

FIG. 6 is a schematic view of a balloon adapted to lift an image capturing arrangement to altitude,

FIG. 7 provides a chordwise cross sectional view through an exemplary aerofoil employed on the UAV of FIG. 5, showing an exemplary image capturing arrangement integrated into the aerofoil,

FIG. 8 is a schematic diagram of an exemplary ancillary unit,

FIG. 9 is an exemplary flow diagram showing the steps involved in using the image capturing system, and

FIG. 10 is a schematic diagram showing the angle of a second image correlated to a star index.

### DETAILED DESCRIPTION OF EMBODIMENT(S)

In an embodiment, an image capturing arrangement is elevated above the Earth to the stratosphere and arranged to capture images of the Earth's surface with the first image capturing device. The second image capturing device captures images of stars at generally the same time as the first image capturing device is capturing images.

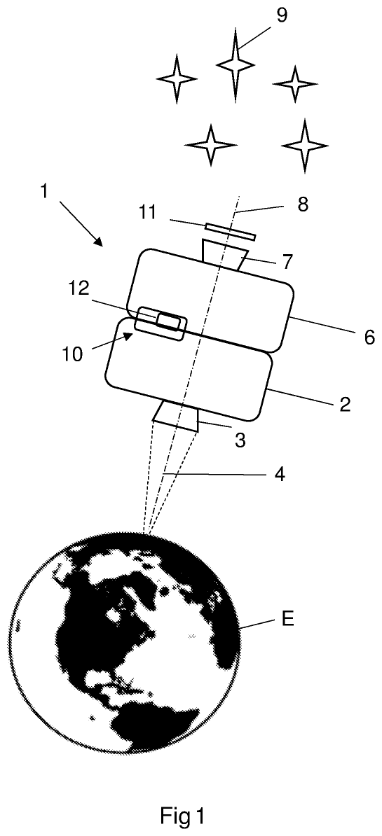

FIGS. 1 to 4 and FIG. 6 illustrate various exemplary image capturing arrangements that could be used in this embodiment. Each image capturing arrangement comprises one or more first image capturing devices pointing towards an object, in this embodiment the Earth, and one or more second image capturing devices pointing towards the stars.

In FIG. 1, the image capturing arrangement 1 comprises a first image capturing device 2 capturing first images. The first image capturing device 2 is a camera with a first lens 3 having a first image capturing axis 4 (optical or principal axis) pointing towards the Earth E. A second image capturing device 6, capturing second images, is also a camera having a second lens 7 with a second optical axis 8 pointing towards the stars 9. Both cameras operate in the visible light part of the electromagnetic spectrum, and in this embodiment are digital cameras, e.g. with CCD arrays.

The second camera 6 is fitted with an infra-red lens filter, which allows only light at infrared wavelengths of the electromagnetic spectrum to pass through to the second camera lens 7. The filter absorbs visible light, in order to filter out daylight when capturing images of stars during the day. This filter 11 may not be required if the first images are being captured at night.

The term ‘optical axis’ or ‘principal axis’ is used to refer to the image capturing axis since in this embodiment the camera records visible light. However, it is to be understood that in alternative embodiments, the camera may be a sensor capturing images in a non-visible part of the electromagnetic spectrum.

The camera arrangement 1 also includes an ancillary unit 10 including a reference clock 12, such that when capturing images, the time of taking the images can be recorded and stored with each image. The time recorded includes date as well as time information. Images captured by the first camera 2 and the second camera 6 may be taken simultaneously or may be phased over time.

In FIG. 1, the first 2 and second 6 cameras are arranged generally opposing each other i.e. back-to-back, such that their principal axes 4, 8 are generally 180 degrees apart. The orientation of the first camera 2 to the second camera 6 is accurately known as part of the arrangement.

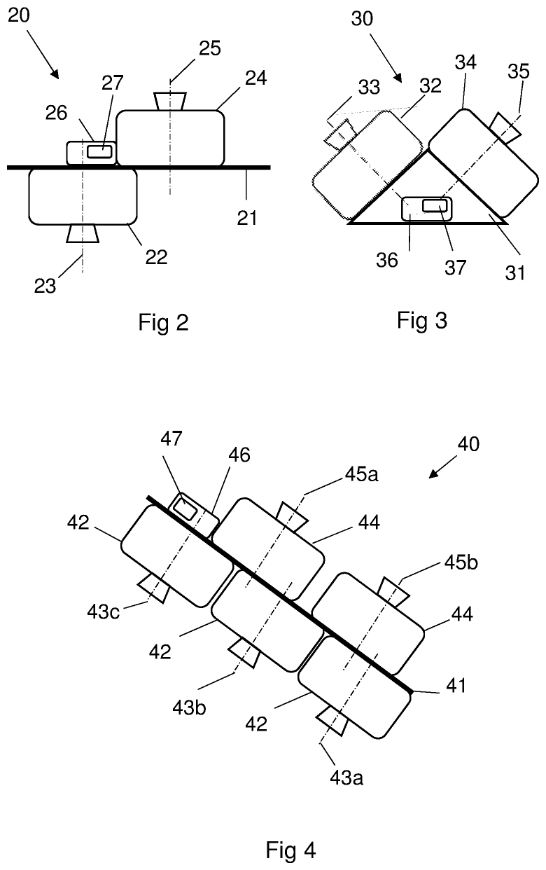

The image capturing arrangements in FIGS. 2 to 4 show other exemplary camera arrangements. In FIG. 2, the image capturing arrangement 20 has a first camera 22 and a second camera 24 arranged on a platform 21 with an ancillary unit 26 including a reference clock 27. The first 23 and second 25 image capturing axes are offset or set apart from each other along the generally linear axis of the platform 21. In FIG. 3, the first 32 and second 34 cameras are arranged on a platform 31, with an ancillary unit 36 including a reference clock 37. The first 33 and second 35 image capturing axes are arranged at a known angle to each other. FIG. 4 shows a camera arrangement 40 with three first cameras 42 and two second cameras 44 arranged on a platform 41 with an ancillary unit 46 containing a reference clock 47. The offset between the first image capturing axes 43a, 43b, 43c of the each of first cameras 42 and the second image capturing axes 45a, 45b of each of the second cameras 44 is known. Each first camera 42 may be recording images at a different part of the electromagnetic spectrum and be based on different technology, alternatively all first cameras 42 may be identical.

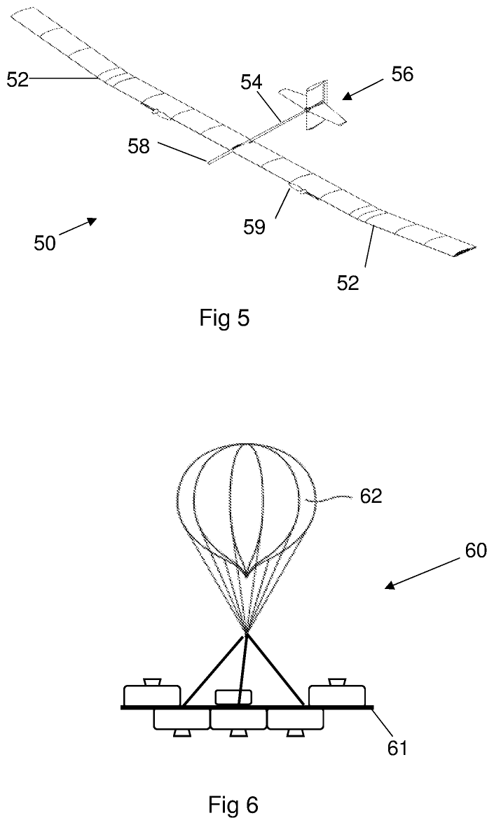

The camera arrangement 1, 20, 30, 40 is elevated to a target altitude by an aerial vehicle. The vehicle in this embodiment is an unmanned aerial vehicle (UAV) as shown in FIG. 5, which is lifted to altitude by a balloon and then released into its flight mode. Alternatively, a camera arrangement 60 could be suspended on a platform 61 from a balloon 62 operating at altitude as shown in FIG. 6. Operating in the stratosphere offers the advantage of calmer atmospheric conditions, however any target altitude is possible, and a land based, sea based or aircraft or spacecraft operating at an altitude lower than the stratosphere could also be used.

The exemplary UAV 50 shown in FIG. 5 has two wings 52, a fuselage 54, and a tailplane 56. In this embodiment the fuselage 54 is a minimal structure, comprising simply a lightweight tube, with the wings 52 and tailplane 56 attached to the tube. The fuselage 54 has a nose 58 extending forwards of the wings 52, acting to counter balance the weight of the tailplane 56, and also providing optional payload storage capacity.

The wings 52 are elongate in a spanwise direction with a total wingspan of around 20 to 60 metres, extending either side of the fuselage 54. Each wing 52 comprises a space frame having a plurality of interlocking ribs and spars.

Each of the wings 52 carry a motor driven propeller 59 which may be powered by rechargeable batteries, or the batteries may be recharged during flight via solar energy collecting cells (not shown) located on the external surface of the aircraft, e.g. on the wings 52. The UAV 50 can therefore fly for extended periods of time, for days or months at a time. The vehicle 50 typically includes an automated control system for flying the UAV 50 on a predetermined flight path. The UAV 50 is capable of straight level flight, and can turn and fly at inclined angles or roll, pitch and yaw.

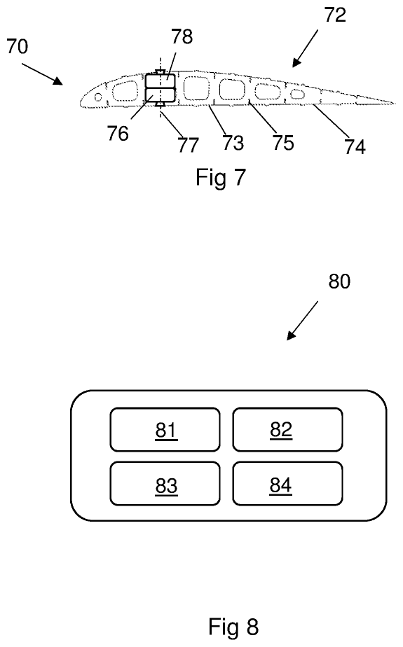

In this embodiment, a camera arrangement 70 is located within the wing structure 72 of the UAV, as shown in the chordwise cross sectional view through the aerofoil in FIG. 7. Equally, one or more camera arrangements could be located within the aerofoil of the tail plane, on the fuselage, or on or in any other part of the UAV with due regard to weight distribution.

Ribs 74 extend chordwise across the wing 72, and are spaced equidistantly apart in a spanwise direction. Each rib 74 interlocks with a series of spars (not shown) extending generally perpendicularly to the ribs 74. The spars and ribs 74 have slots 75 which enable interlocked joints to be formed. In this manner, hollow cells are formed between adjacent ribs 74 and spars. Upper and lower covers are then placed over the upper and lower surfaces of the space frame to form the wing. The camera arrangement 70 is located within a hollow cell at approximately the quarter chord position of the wing since this is the largest cell within the wing 52 and provides optimal weight balance in the chordwise direction. Any other hollow cell within the wing could alternatively be used, and the weight balanced in conjunction with, for example, payload distribution.

The first camera 76 in the camera arrangement 70 of FIG. 7 has an optical axis 77 extending from the lower surface 73 of the rib 74. FIG. 7 shows the optical axis 77 of the first camera 76 oriented generally perpendicularly in relation to the lower surface 73 of the wing 72, however any suitable angle for the camera arrangement 70 within the wing 72 may be chosen. In flight, the UAV has a wing span which is of such length that the wing may flex, potentially both in a spanwise and/or chordwise direction. This may lead to variation in the angle of the lower surface 73 of the wing 72 from where the first camera captures images, in addition to any roll, pitch or yaw variation of the main structure of the UAV.

FIG. 8 shows an embodiment of the ancillary unit, 80. The ancillary unit 80 contains the reference clock 81 and also houses a data storage module 82, a data transmission and/or receiving module 83 and an image data processing module 84. In alternative camera arrangements, there may be one or more ancillary units 80, containing data storage 82 and any combination of data receiving, transmission 83 and processing modules 84. The ancillary unit 80 may be located on the UAV or aerial vehicle but remotely of the camera arrangement. In some embodiments, image data may be processed on board the camera arrangement or aerial vehicle, in other embodiments image data processing occurs remotely, for example on the ground on Earth or from an alternative vehicle located remotely from the aerial vehicle on which the camera arrangement is located. Alternatively, a limited amount of image processing may occur within the camera arrangement, with the results transmitted remotely for further processing. If no image data processing occurs at the camera arrangement, then an image processing module 84 is not required and can be omitted from the ancillary unit 80. The ancillary unit 80 may also contain a positioning receiver, as described below.

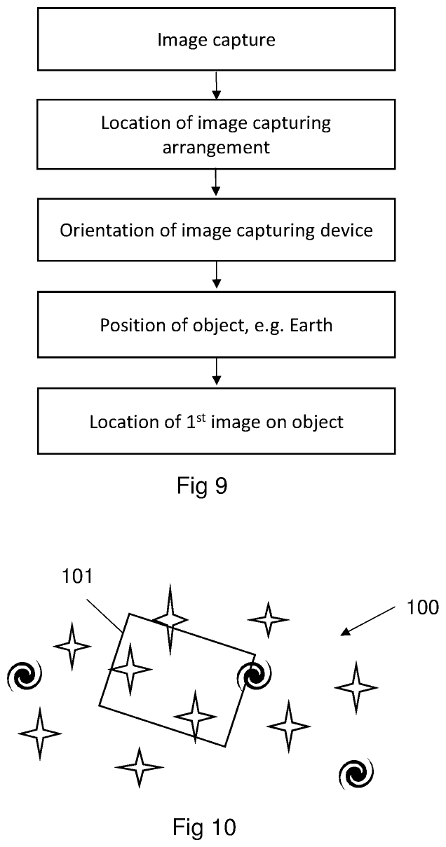

FIG. 9 provides an overview of the steps involved in the operation of the camera arrangement and system described above. These are briefly described here and then each step is considered in detail in the following paragraphs. The following description assumes that the camera arrangement of FIG. 1 is used in conjunction with the UAV of FIG. 5, and accordingly the reference numerals of FIGS. 1 and 5 are provided in the text below. One or more images of the object and the stars are captured by the camera arrangement 1. In the current embodiment, the first camera 2 captures images of the Earth's surface E for the purpose of mapping the Earth's surface. The second camera captures images of stars 9 for the purpose of ascertaining the attitude or orientation of the camera arrangement 1, and potentially also for determining the location (spatial position) of the camera arrangement 1 with respect to the Earth E. The spatial position of the camera arrangement 1 in terms of latitude, longitude and altitude, and the orientation of the camera arrangement 1, are determined in order to define the direction of the first image capturing axis 4 and the spatial location of the first camera 2 with respect to the Earth E. Information on the orbit and rotational position of the Earth E is then correlated with the position of the first image capturing axis 4 in order to ascertain the location on the Earth E of the image(s) that have been captured.

Multiple images are captured by the first camera 2, typically at a rate of around 5 frames per second. The position of the images on the Earth's surface E is calculated according to the steps above in order to build up a set of images mapping the Earth's surface E.

Whilst this embodiment relates to mapping the Earth's surface, it will be appreciated that images could be captured by the first camera 2 of, for example the Earth's atmosphere, e.g. cloud patterns, or the Moon, Mars or other celestial body.

### Image Capture Operation:

Once the UAV 50 is at the target altitude and on its intended flight path, the camera arrangement 1 can be brought online ready to capture images. Control of the camera arrangement 1 and each first 2 and second 6 camera occurs in this embodiment via the UAV's control system. The flight path of the UAV is calculated such that the camera arrangement 1 will be optimally located to capture images of relevant parts of the Earth's surface E. As the first camera 2 captures images of the Earth E, so the second camera 6 captures images of stars 9 along the second optical axis 8 in the generally opposite and known direction to the optical axis 4 of the first camera 2. All images have a time stamp associated with the time the image is captured, provided by the reference clock 12 located in the ancillary unit 10.

The first camera 2 and second camera 6 may be arranged to capture images simultaneously, so they are directly correlated in time. Alternatively, first image and second image capture may occur at different times, in which case each first image will correlate to a point in time offset from the time of adjacent second images.

### Determination of the Location of the Image Capturing Arrangement in Space:

Accurate positioning in terms of latitude, longitude and altitude of the camera at the time of image capture may be obtained via triangulation of multiple images of stars or by the use of a positioning system such as a GPS (Global Positioning System) device.

For example, the camera arrangement 1 could be equipped with a positioning receiver which records the latitude, longitude and altitude of the camera arrangement 1 relative to the Earth E. A commonly available system such as a GPS receiver could be used, calculating position according to information received from satellites arranged in the Earth's atmosphere. Other positioning systems are available and could alternatively be used, for example GLONASS (GLObal NAvigation Satellite System). If the object is not the Earth but another celestial body such as the Moon or Mars, then the positioning receiver would need to access satellites arranged in the atmosphere or space around that celestial body, which would need to be in place and providing communication signals for location purposes.

Alternatively, the position of the camera arrangement can be determined from the star images captured by the second camera 6. By comparing a star image captured by the second camera with star images taken from a known repository such as those mentioned below under orientation of the camera arrangement, and triangulating a plurality of star images provides the position in space of the camera arrangement at the time of the second image can be determined. Use of a GPS receiver together with analysis of star images to provide latitude, longitude and altitude information is also possible.

### Determination of the Orientation of the Camera Arrangement:

Using the star images captured by the second camera 6 and comparing these with a repository of known star images it is possible to determine the orientation of the second camera 6. Since the orientation of the first camera 2 relative to the second camera 6 is known, this allows the orientation of the first camera 2 and the first optical axis 4 to be determined. Having retrieved the first and second images from the camera arrangement 1, star images are uploaded to a star tracking system, e.g. Astrometry.net or a similar astrometry plate solving system.

The system compares an index of known star locations with the second images. The Astrometry.net index is based on star catalogues: USNO-B, which is an all sky catalogue and TYCHO-2, which is a subset of 2.5 million brightest stars. Alternative star catalogues exist and could be used. Stars and galaxies in each second image are identified and compared with the index, and a position and rotation of the second image 101 on the sky 100 is returned. A schematic example is as shown in FIG. 10. According to Astrometry.net, the system uses an image, compares the image with the star catalogue and provides positional information according to the astrometry world coordinate system (WCS), which is a standards-based description of the transformation between image coordinates and sky coordinates.

Alternative star tracking systems are known, for example the Star Tracker 5000 from the University of Wisconsin-Madison, which determines its attitude with respect to an absolute coordinate system by analysing star patterns in a particular image frame. The ST5000 also uses a star catalogue for reference.

The angle of declination and therefore the location of the principal axis of the first or mapping camera can thereby be provided to sub arc second accuracy. Knowing where the image captured by the second camera 6 is located and how the image is angled enables the orientation of the second camera 6 to be established.

Since the orientation of the first camera 2 to the second camera 6 is known, the location and direction of the first optical or principal axis 4 is therefore determined.

The steps above may be carried out in a different order to that described above. For example, positional information may be recorded via a GPS receiver at the same time as images are being captured, this may be relevant if the aerial vehicle is travelling at a significant speed. Equally, the orientation of the camera arrangement may be processed on board as the image(s) are captured. Alternatively, the camera arrangement may simply capture images with a corresponding time stamp and transmit this data via a data link to the remote station for analysis. The location of the camera arrangement may be determined from the second images, in which case the location and orientation determination can occur as a single step.

### Determination of the Position of the Object, e.g. the Earth:

Information on the Earth's location in its orbit and also its rotational position at the time stamp of each first image allows the correlation of the first image capturing axis 4 and the Earth's position and orientation to determine the location of the first image.

Using a series of images of the Earth E captured and processed according to this method enables the Earth's surface to be accurately mapped, to an accuracy of 1 metre squared on the surface of the Earth.

In alternative embodiments, the object may be a celestial object other than the Earth, for example images may be captured of the Moon, its surface, atmosphere, orbit etc or similarly for Mars or other stars or galaxies. For example, the camera arrangement 30 of FIG. 3 could be located in the stratosphere above the Earth E. Using the position and orientation of the camera arrangement 30 relative to the Earth E determined as outlined above for the previous embodiment, the location of the principal axis 33 of the first camera 32 can be determined. The spatial position and orientation of the object may be obtained by reference to an information repository, which may provide location information relative to star positions or relative to the Earth's position. The spatial position and orientation of the object is correlated with the position and orientation of the camera arrangement 30, and hence the principal axis 33 of the first camera, to determine the location of the first images(s) on the object. This may require translation between different coordinate systems, and the use of for example the longitude, latitude and altitude data relative to the object to be provided by a satellite receiver receiving signals from a satellite system in place in orbit round the object. Alternatively, if the location and orientation of the camera arrangement and the object is known according to the same coordinate system relative to the Earth, or relative to the stars, then the location and orientation relative to each other can be determined.

Although the invention has been described above with reference to one or more preferred embodiments, it will be appreciated that various changes or modifications may be made without departing from the scope of the invention as defined in the appended claims.

What is claimed is:

1. An image data capturing arrangement for an aerial vehicle, comprising:
at least one first image data capturing device adapted to capture data of one or more first images of an object along a first image capturing axis,
at least one second image data capturing device adapted to capture data of one or more second images of stars along a second image capturing axis,
the second image capturing axis having a known orientation relative to the first image capturing axis, and
a reference clock for assigning a time stamp to each first and second image data.

2. An image data capturing arrangement according to claim 1, wherein the first image data capturing device or second image data capturing device is adapted to capture data of images based on one or more ranges of wavelengths of electromagnetic radiation within a spectrum, the range of wavelengths corresponding to that of visible light or ultra violet or X-ray or gamma ray or infra-red or microwave or radio waves or any other part of the spectrum.

3. An image data capturing arrangement according to claim 1, wherein the first image data capturing device or second image data capturing device is a camera, a radio detecting and ranging (RADAR) sensor or a Light Detection and Ranging (LiDAR) sensor.

4. An image data capturing arrangement according to claim 1, wherein the first image data capturing device is a different type of device than the second image data capturing device.

5. An image data capturing arrangement according to claim 4, wherein the first image data capturing device is adapted to capture data of one or more object images based on a first range of wavelengths of electromagnetic radiation within a spectrum, and the second image data capturing device is adapted to capture data of one or more star images based on a second range of wavelengths of electromagnetic radiation within the spectrum different than the first range of wavelengths.

6. An image data capturing arrangement according to claim 1, wherein the object is the Earth.

7. An image data capturing arrangement according to claim 1, wherein the second image data capturing device includes an infra-red filter.

8. An image capturing arrangement according to claim 1, wherein the image data capturing arrangement includes a data storage module.

9. An image capturing arrangement according to claim 1, wherein the image data capturing arrangement includes a data transmission module.

10. An image data capturing arrangement according to claim 1, wherein the image data capturing arrangement includes an image data processing module.

11. An image data capturing system comprising the image data capturing arrangement according to claim 1, and further comprising a position determining device arranged to determine a spatial position of the image data capturing arrangement relative to the object.

12. An image data capturing system according to claim 11, wherein the position determining device is configured to determine a spatial position of the image data capturing arrangement by accessing a repository of star image data and correlating star image data from the repository with a plurality of second image data of stars captured by the second image data capturing device.

13. An image data capturing system according to claim 11, further comprising a receiver for receiving satellite signals and the position determining device is arranged to determine the spatial position of the image data capturing arrangement relative to the object according to the satellite signals received.

14. An image data capturing system according to claim 11, wherein the position determining device is configured to determine one or more of the latitude, longitude, altitude and attitude of the image data capturing arrangement.

15. An image data capturing system according to claim 11 wherein at least a part of the position determining device is arranged remotely from the image data capturing arrangement.

16. The image data capturing system according to claim 11, further comprising an information repository providing the object's position and orientation over time with respect to the stars.

17. The image data capturing system according to claim 11, further comprising a processor configured to use the object's position and orientation correlated with the reference clock together with the spatial position of the image data capturing device in order to determine the location of the or each captured first image data on the object and assign object reference location data to the or each first image data.

18. The image data capturing system according to claim 17, wherein the processor is remote from the image data capturing arrangement.

19. An aerial vehicle comprising the image data capturing arrangement according to claim 1.

20. A method of capturing image data comprising the steps of:
providing an image data capturing arrangement including at least one first image data capturing device adapted to capture data of one or more first images of an object along a first image capturing axis, at least one second image data capturing device adapted to capture data of one or more second images of stars along a second image capturing axis and a common reference clock,
capturing data of one or more first images of the object with the first image data capturing device,
capturing data of one or more second images with the second image data capturing device, the second image capturing axis having a known orientation relative to the first image capturing axis,
assigning a time stamp to each first image data and each second image data with the common reference clock.

21. A method according to claim 20, further comprising correlating the one or more first image data with the one or more second image data according to the time stamp of each first image data and each second image data.

22. A method according to claim 20, further comprising determining a spatial position of the image data capturing arrangement.

23. A method according to claim 22, further comprising determining the spatial position of the image data capturing arrangement relative to the object according to satellite signals received.

24. A method according to claim 22, further comprising determining the spatial position of the image data capturing arrangement by accessing a repository of star image data and correlating star image data from the repository with a plurality of second image data of stars captured by the second image data capturing device.

25. A method according to claim 22, further comprising determining one or more of the latitude, longitude, altitude and attitude of the image data capturing arrangement.

26. A method according to claim 22, further comprising determining the location on the object of the or each captured first image data using the spatial position of the image data capturing device together with information on the object's position and orientation at the time stamp of the or each first image data.

27. A method according to claim 26, wherein the method step of determining the location on the object of each captured first image data is repeated for each first image data in a series of first image data in order to map at least part of the object.

28. A method according to claim 26, wherein one or more of the steps of correlating first image data with second image data, determining image data capturing device spatial position, and determining the location on the object of the or each captured first image data occurs remotely of the image data capturing arrangement.

29. A method according to claim 20, wherein the object is the Earth.

30. A method according to claim 20, further comprising mounting the image data capturing arrangement to an aerial vehicle, flying the aerial vehicle and capturing first and second image data during flight.
